(19) United States
(12) Patent Application Publication
(10) Pub. No.: US 2021/0229626 A1
(43) Pub. Date: Jul. 29, 2021

(54) ANCHOR ATTACHMENT DETECTION SENSORS

(71) Applicant: GM Global Technology Operations LLC, Detroit, MI (US)

(72) Inventors: Orhan Demirovic, Sterling Heights, MI (US); Tricia E. Morrow, Grosse Pointe, MI (US); Eugene J. Lau, Mississauga (CA)

(21) Appl. No.: 16/776,074

(22) Filed: Jan. 29, 2020

(51) Int. Cl. B60R 22/48; B60N 2/28; B60R 22/26; G01L 5/04

(52) U.S. Cl. CPC B60R 22/48; B60N 2/2893; B60R 2022/485; G01L 5/04; B60N 2/286; B60R 22/26

(57) ABSTRACT

An anchor attachment detection sensor for a vehicle. An anchor associated with a passenger seat includes an attachment loop. The anchor attachment detection sensor also includes a sensor affixed on and fully supported by the attachment loop. The sensor detects an interaction applied to the attachment loop and sensor by a child safety seat connector. A method of detecting the attachment of a child safety seat connector to an anchor in a motor vehicle includes detecting an interaction of the child safety seat connector with an attachment loop of an anchor using a sensor supported by the attachment loop and determining with a microprocessor control system coupled to the sensor if a child safety seat connector has been coupled to the anchor based on the interaction detected by the sensor.

### INTRODUCTION

The present disclosure relates to attachment detection sensors for lower anchor and tethers for children systems.

A number of safety mechanisms have been incorporated into vehicles for preventing or reducing injury in case of a vehicle crash. Seatbelts, for example, assist in restraining passengers. Airbags, used in combination with seatbelts, provide cushioning and restraint of occupants. Child safety seats, including child restraint seats (CRS) and belt-positioning booster seats, position children within a passenger seat and may be used in conjunction with seatbelts, with lower anchors and tethers for children (LATCH) systems, with only lower anchors, or with a seatbelt and an upper anchor incorporated in vehicle passenger seats, for restraining children in a passenger seat. In addition, various warning indicators may warn the occupants if an occupant is detected but certain parameters have not been met, such as an unbuckled seatbelt.

It has been found, however, that the use of certain safety systems may be redundant or improper. In one example, the deployment of airbags generate forces that may be too high for children secured in a child safety seat or for children below a certain size and weight seated in a passenger seat. Accordingly, systems have been developed to manually and automatically deactivate airbags associated with a given seat. For example, a weight sensing system may be used to automatically deactivate an airbag by sensing and measuring the weight of an occupant in a given seat. If the weight is less than a threshold, the airbag(s) associated with that seat is deactivated. In some situations, however, the combination of a child and a child safety seat may result in a weight measurement that is above the threshold for deactivating the airbags associated with that seat where a manual deactivation is required. In another example is the failure to properly affix a child safety seat to an anchor. Yet a further example is the redundant use of a seat belt in combination with the use of the lower anchors of a LATCH system.

Thus, while current passenger restraint systems and safety systems achieve their intended purpose, there remains room for the development of a new and improved detection device and method for sensing a child safety seat secured in a passenger seat.

### SUMMARY

According to several aspects, an anchor attachment detection sensor for a vehicle includes an anchor associated with a passenger seat. The anchor includes an attachment loop. The anchor attachment detection sensor also includes a sensor affixed on and fully supported by the attachment loop. The sensor detects an interaction applied to the attachment loop and sensor by a child safety seat connector.

In further aspects, the interaction applied to the attachment loop includes one of the following: a force applied to the attachment loop, a strain on the attachment loop, a vibration of the attachment loop, noise proximate to the attachment loop, and a displacement of the attachment loop.

In additional aspects, the sensor includes at least one sensor selected from the group consisting of a strain gauge, an accelerometer, an acoustic transducer, a piezo-electric sensor, a load cell, and a contact switch.

In additional aspects, the sensor is a strain gauge and the strain gauge measures both axial strain and bending strain.

In further aspects, the sensor is a strain gauge.

In further aspects, the sensor is a conductive paint.

In additional aspects, the sensor is chemically or mechanically connected to the attachment loop.

In further aspects, the sensor is adhered to the attachment loop with a polymer material.

In further aspects, the sensor is welded to the attachment loop.

In further aspects, wherein the sensor is mechanically affixed to the attachment loop.

In further aspects, a clip affixes the sensor to the attachment loop.

In further aspects, the sensor includes one of a contact sensor and a load sensor.

In further aspects, the sensor is a contact sensor that includes a contact switch.

In further aspects, the clip defines a perimeter and the sensor is located within the perimeter.

In further aspects, the attachment loop includes at least two side arms and the clip attaches to the at least two side arms.

In further aspects, the sensor includes a contact sensor. The contact sensor includes a sensor housing connected to the clip, a base plate located within the sensor housing, a spring connected to the base plate, an engagement plate extending between the at least two side arms, the engagement plate connected to the spring, and a first sensor contact mounted to the base.

In further aspects, the first sensor contact is a reed switch and the engagement plate includes a second contact, wherein the second contact includes a magnet.

In further aspects, the first sensor contact is a piezo-electric sensor.

In further aspects, the first sensor contact is a first electrical conductor and the engagement plate includes a second contact, wherein the second contact is a second electrical conductor.

According to several aspects, a method of detecting the attachment of a child safety seat connector to an anchor in a motor vehicle includes detecting an interaction of the child safety seat connector with an attachment loop of an anchor using a sensor supported by the attachment loop. The method further includes determining with a microprocessor control system coupled to the sensor if a child safety seat connector has been coupled to the anchor based on the interaction detected by the sensor.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A illustrates a child safety seat secured to a passenger seat in a motor vehicle according to an exemplary embodiment;

FIG. 1B illustrates rigid arms used to strap a child safety seat according to an exemplary embodiment;

FIG. 2A illustrates child safety seat connectors according to an exemplary embodiment;

FIG. 2B illustrates child safety seat connectors according to an exemplary embodiment;

FIG. 2C illustrates child safety seat connectors according to an exemplary embodiment;

FIG. 3 illustrates a child safety seat connector coupled to an attachment loop of an anchor according to an exemplary embodiment;

FIG. 4 is illustrates a vehicle interior including passenger seats according to an exemplary embodiment;

FIG. 5 illustrates an anchor affixed to a cross-member in a vehicle according to an exemplary embodiment;

FIG. 6 illustrates another aspect of an attachment detection sensor according to an exemplary embodiment;

FIG. 7A illustrates an attachment loop including an anchor attachment detection sensor associated with an anchor according to an exemplary embodiment;

FIG. 7B is cross-section of FIG. 7A illustrating the tines of the clip according to an exemplary embodiment;

FIG. 7C is cross-section of FIG. 7A illustrating the tines of the clip according to an exemplary embodiment;

FIG. 7D illustrates a close-up view of the anchor attachment detection sensor of FIG. 7A according to an exemplary embodiment; and

FIG. 8 illustrates a method of detecting anchor attachment according to an exemplary embodiment.

### DETAILED DESCRIPTION

The following description is merely exemplary in nature and is not intended to limit the present disclosure, application, or uses.

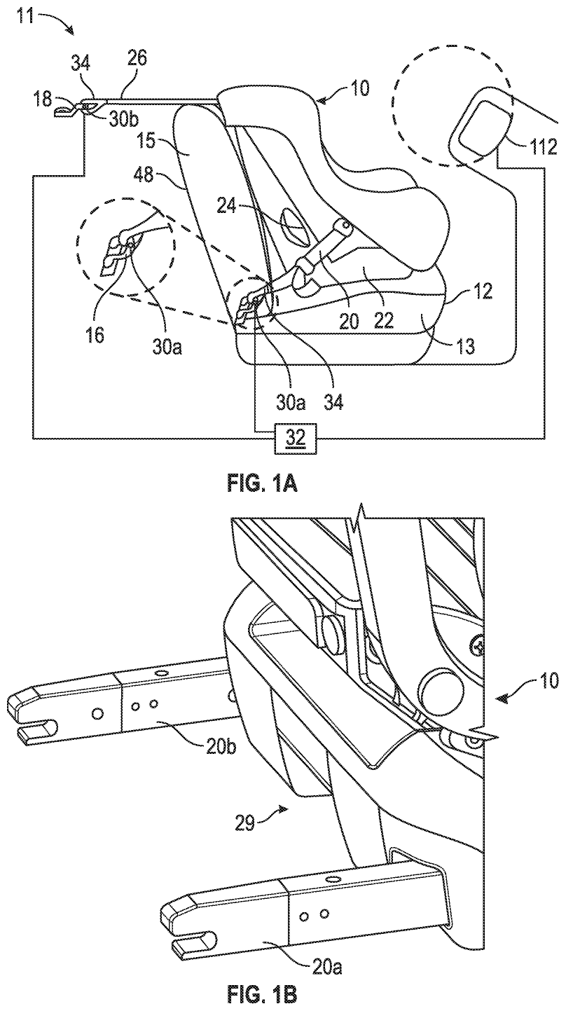

Lower Anchor and Tether for Children (LATCH) systems are utilized in vehicles as an alternative, or as an additional, mechanism to seatbelts for securing child safety seats, including child restraint seats and belt-positioning booster seats, into vehicle passenger seats. LATCH systems generally include lower anchors and an upper anchor affixed to a vehicle and associated with a given passenger seat. Referring to FIG. 1A, a child safety seat 10 and LATCH system 11 are illustrated. In this illustration, the child safety seat 10 is an infant or convertible child safety seat 10 secured in the forward facing direction. However, it may be appreciated that the child safety seat 10 may be secured in the rear facing direction or may instead be a belt-positioning booster seat. In the forward facing position, the child safety seat 10 rests on the seat cushion 13 and seat back 15 of the passenger seat 12.

The LATCH system 11 includes two lower anchors 16 (only one is illustrated), which extend between the seat cushion 13 and the seat back 15 of the passenger seat 12, and an upper anchor 18 located behind the passenger seat 12. One or more straps 20 are provided to couple the child safety seat 10 to the lower anchors 16. As illustrated, a strap 20 is connected to each side 22 of the child safety seat 10. In alternative aspects, a single strap 20 may be passed through a strap routing path 24 provided in the child safety seat 10, an aspect of which is illustrated in FIG. 1A, or the strap 20 is otherwise affixed to the child safety seat 10. In further alternative aspects, the strap(s) 20 are provided by rigid arms 20a, 20b as illustrated in FIG. 1B, which extend from the base 29 of the child safety seat 10. Child safety seats 10, including those illustrated in FIG. 1A and FIG. 1B, also include a tether 26. The tether 26 connects the upper portion of the child safety seat 10 to the upper anchor 18. It should be appreciated that, in aspects, the strap(s) 20 and tether 26 are formed from a flexible material upon which tension is applied by, e.g., threading the strap(s) 20 or tether 26 through a buckle (not illustrated) or otherwise securing the strap(s) 20 or tether 26 to itself. Tension may also be applied using, e.g., an elastic member such as a spring. Alternatively, as noted above, the strap(s) 20, or tether 26, is formed from a rigid material.

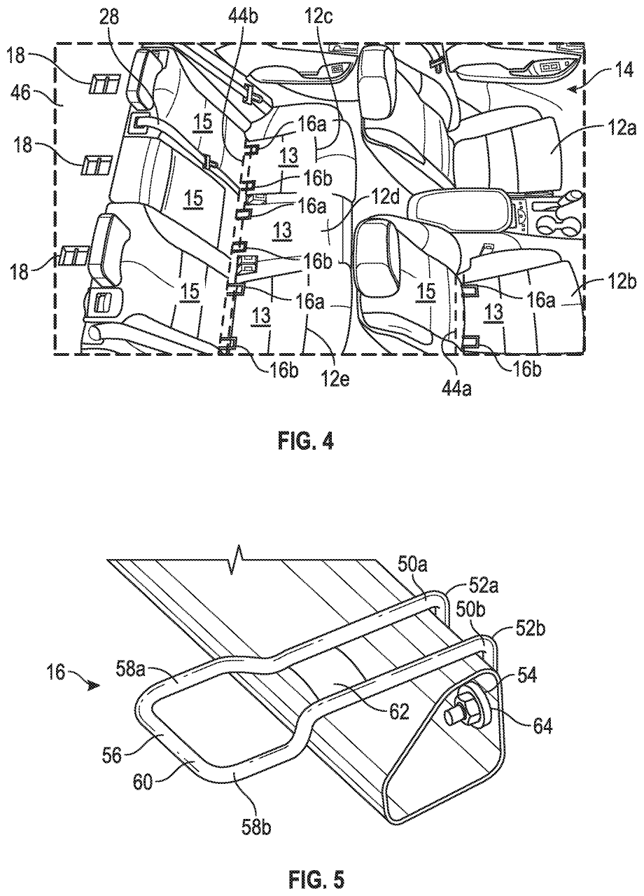

In aspects where the child safety seat 10 is positioned in the rear facing position (not illustrated), the lower anchors 16 are used to secure the child safety seat 10 into the passenger seat 12. The tether 26 and upper anchor 18 may also be used in the rear facing position. In alternative aspects, the child safety seat 10 may be secured to the passenger seat 12 using the seatbelt 28 associated with the passenger seat (see FIG. 4) alone, or in combination with either the strap(s) 20, tether 26, or both the strap(s) 20 and tether 26 of the LATCH system 11.

In aspects, the lower anchors 16 are rigid and do not move or change in shape. Alternatively, the lower anchors 16 are flexible. Similarly, in aspects, the upper anchor 18 is rigid and does not move or change in shape. Alternatively, the upper anchor 18 is flexible. It should be appreciated that all rigid, all flexible, or combinations of all rigid and all flexible lower anchors 16 and upper anchors 18 may be used. For example, rigid lower anchors 16 may be used in combination with a flexible upper anchor 18, or flexible lower anchors 16 may be used in combination with a rigid upper anchor 18.

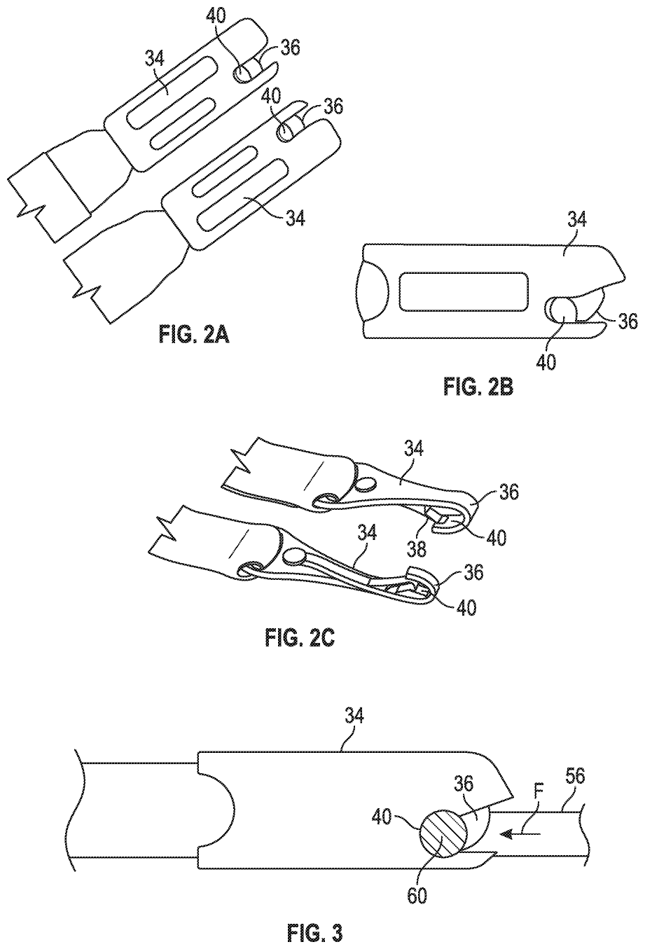

The straps 20 and tether 26 of a child safety seat 10 are connected to the lower anchors 16 and upper anchors 18 using child safety seat connectors 34, which are affixed to the strap(s) 20 and the tether 26. FIGS. 2A, 2B and 2C illustrate various aspects of the child safety seat connectors 34. Each child safety seat connector 34 includes a hook 36 and a biased closure 38, which closes the child safety seat connector 34 around the lower anchors 16 or upper anchor 18 to secure the strap(s) 20 or tether 26, respectively. In addition, a child safety seat connector 34 defines an opening 40 in which the attachment loop bar 60 of either the lower anchor 16 or upper anchor 18 is received as illustrated in FIG. 3 and described further below.

Referring again to FIG. 1A, anchor attachment detection sensors 30a, 30b (collectively referred to as anchor attachment detection sensors 30) are provided for at least one anchor 16, 18 associated with a given passenger seat 12. FIG. 1A illustrates a lower anchor attachment detection sensor 30a associated with each lower anchor 16 and an upper anchor attachment detection sensor 30b associated with the upper anchor 18. When the strap(s) 20 is connected to the lower anchors 16a, 16b, each lower anchor attachment detection sensor 30a transmits a control signal to a microprocessor control system (MCS) 32 indicating the strap(s) 20 have been connected to each of the lower anchors 16a, 16b. Similarly, when the tether 26 is connected to the upper anchor 18, the upper anchor attachment detection sensor 30b transmits a control signal to the microprocessor control system 32 indicating the tether 26 has been connected to the upper anchor 18.

Each anchor attachment detection sensor 30 detects an interaction with the corresponding lower anchor 16 or upper anchor 18, wherein the interaction indicates the connecting of a child safety seat connector 34 to the lower anchor 16 or upper anchor 18. Interactions are detected by detecting at least one of the following with an anchor attachment sensor: a force applied to an anchor, a strain on an anchor, a vibration of an anchor, noise proximate to an anchor, or a displacement of an anchor. In aspects, the anchor attachment detection sensor 30 includes at least one of a strain gauge, an accelerometer, an acoustic transducer, a piezo-sensor, a load cell, and a contact switch. With particular reference to strain gauges, strain gauges are, for example, selected from at least one of an electrical resistor and a piezo-resistor. Further, strain gauges may be configured to measure both axial strain and bending strain. In aspects, strain gauges rely upon at least one electrical resistor selected from the group consisting of a spring, a wire, a vibrating wire, a foil including a metallic trace, a film including a metallic trace, and a conductive paint.

In additional aspects, the anchor attachment detection sensors 30 optionally measure tension applied the lower anchor 16 and upper anchor 18 by the strap(s) 20 and tether 26, respectively. In this aspect, the control signal further indicates the tension on the lower anchors 16 and upper anchor 18. The microprocessor control system 32 includes a control algorithm that receives the control signals from the anchor attachment detection sensors 30 and determines whether the strap(s) 20, tether 26, or both the strap(s) 20 and tether 26 are connected to the lower anchors 16 and upper anchor 18. The microprocessor control system 32, in aspects, includes one or more processors and memory modules for storing and implementing the control algorithm.

The amount of tension applied to the lower anchors 16 and upper anchor 18 may also be determined by measuring strain or force applied to the lower anchors 16 and upper anchors 18. In such aspects, the lower anchor attachment detection sensors 30a and upper anchor attachment detection sensor 30b transmit a control signal to the microprocessor control system 32 to indicate the strain or force applied to the lower anchors 16 and upper anchors 18. The microprocessor control system 32 then utilizes the control signal to determine the amount of tension applied to the lower anchors 16 and upper anchors 18.

In additional aspects, the microprocessor control system 32 optionally includes a control algorithm that receives the control signals from the anchor attachment detection sensors 30 of the lower anchors 16 and determines whether the straps 20 are rigid or flexible by measuring a lapsed time period between an interaction of a strap 20 with a first lower anchor 16 and the interaction the strap 20 (or of a second strap 20) to a second lower anchor 16. If the interactions detected by the lower anchor attachment detection sensors 30 occur simultaneously or within less than a few seconds, such as less than 10 seconds, or less than 5 seconds, or less than 2 seconds, the microprocessor control system 32 determines the straps 20 are rigid straps. If it takes more than a few seconds, such as more than 10 seconds, between interactions with the first lower anchor 16 and the second lower anchor 16, the microprocessor control system 32 determines that the straps 20 are flexible.

Referring again to FIG. 1A, while a forward facing infant or convertible child safety seat 10 is illustrated, the child safety seat 10 can be forward facing, rear facing or both forward and rear facing. Such seats also include their own safety harness for retaining the child within the child safety seat 10, often referred to as child restraint seats. In addition, the child safety seat 10 may alternatively be a belt-positioning booster seat or a variation thereof depending on at least one of the age, weight and height of the child. It should, therefore, be appreciated that depending on the configuration of the child safety seat 10 and user preference, one or more of the lower anchors 16, upper anchor 18, and seatbelt 28 (see FIG. 4), may be used to secure the child safety seat 10 to the passenger seat 12.

FIG. 4 illustrates the positioning of lower anchors 16a, 16b and upper anchors 18 in a vehicle interior 14. The passenger seats 12a, 12b, 12c, 12d, 12e include a driver seat 12a and front passenger seat 12b and three rear passenger seats 12c, 12d, 12e. Associated with each passenger seat 12 is a seatbelt 28. In the aspect illustrated, a set of lower anchors 16a, 16b are associated with the passenger seats 12c, 12d, 12e. A set of lower anchors 16a, 16b may also be associated with the front passenger seat 12b, as illustrated, and, in additional aspects not illustrated, the passenger seat 12a. The lower anchors 16a, 16b are connected to a cross member 44, such as a crossbeam 44a, that forms a part of the vehicle frame, or a cross bar 44b that is integrated into a passenger seat 12b. Further, an upper anchor 18 is associated with each rear passenger seat 12c, 12d, 12e and located in the rear deck 46. An upper anchor 18 may also be associated with the front passenger seat 12b and placed at either in the rear 48 (see FIG. 1A) of the passenger seat 12 or integrated into the vehicle roof or floor. Similarly, if the rear passenger seats 12c, 12d, 12e are captains' chairs or if the rear deck 46 is not present, the upper anchor 18 may be placed at either the rear 48 of the passenger seats 12c, 12d, 12e, integrated into the roof or in the floor (not illustrated). It should be further appreciated that, while FIG. 4 does not include lower anchors 16 and upper anchor 18 in passenger seat 12a; lower anchors 16 and an upper anchor 18 may be included in the passenger seat 12a. Similarly, while lower anchors 16 and upper anchors 18 are included in passenger seats 12b, 12c, 12d, 12e, lower anchors 16 and upper anchors 18 may be omitted in any of the passenger seats 12b, 12c, 12d, 12e.

Turning now to FIG. 5, an aspect of a lower anchor 16 is illustrated. The lower anchor 16 includes two legs 50a, 50b (collectively referred to as legs 50), which form hooks 52a, 52b (collectively referred to as hooks 52) that extend from either side of the lower anchor 16. The hooks 52a, 52b are inserted into openings 54 (only one opening is illustrated) in the cross member 44. In the illustrated aspect, opposing the hooks 52a, 52b is an attachment loop 56, which is accessible to passengers and to which the child safety seat 10 is coupled to. In aspects, the attachment loop 56 includes two attachment loop side arms 58a, 58b (collectively 58) and an attachment loop bar 60 extending between the attachment loop side arms 58a, 58b. The attachment loop bar 60 is received within the opening 40 defined by the child safety seat connector 34 as illustrated in FIG. 3. In other aspects, the attachment loop 56 assumes other configurations, such as a circle or a rectangle.

In the illustrated aspect, the legs 50a, 50b extend from the attachment loop 56 and are welded, or otherwise fastened together between the “j” hooks 52a, 52b. Further, the attachment loop 56 includes a bridge 62 between the legs 50a, 50b. In additional aspects, the lower anchor 16 is welded, or otherwise fastened by a mechanical fastener 64, to the cross member 44. The lower anchors 16 are stationary and do not pivot or rotate relative to the cross member 44.

It should be appreciated that, the upper anchor 18 also includes an attachment loop 56, which is received in the opening 40 of a child safety seat connectors 34. In aspects, the upper anchor 18 exhibits the same features as the lower anchors 16. Alternatively, the attachment loop 56 of the upper anchor 18 may consist of just the attachment loop bar 60 or may include only the attachment loop bar 60 and the attachment loop side arms 58. Like the lower anchor 16, the upper anchor 18 is affixed directly to a structural member (not illustrated) in the rear deck 46, in the floor, in the ceiling or in the rear of a passenger seat 12, or other location in front of or behind the passenger seat 12 with which it is associated.

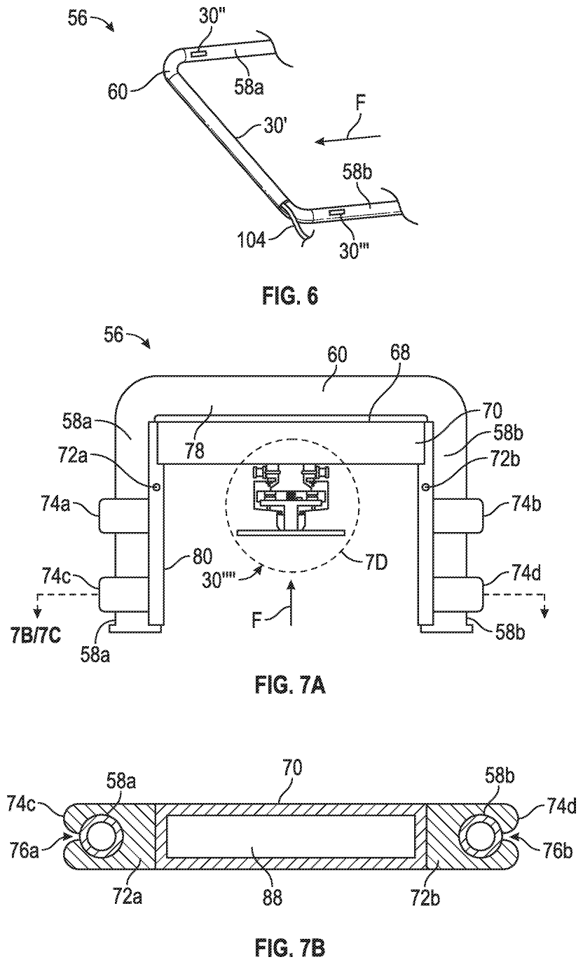

FIG. 6 illustrates an aspect of an attachment loop 56 including three anchor attachment detection sensors 30′, 30″, 30″′ (collectively referred to as anchor attachment detection sensors 30) supported by the attachment loop 56. It should be appreciated that the description herein applies to both lower anchor attachment detection sensors 30a and the upper anchor attachment detection sensors 30b. The first anchor attachment detection sensor 30′ is located on the attachment loop bar 60, the second anchor attachment detection sensor 30″ is located on a first attachment loop side arm 58a, and the third anchor attachment detection sensor 30″′ is located on a second attachment loop side arm 58b. While three anchor attachment detection sensors 30 are illustrated, less than three, such as one or two, may be present or more than three, such as four, five or six may be present.

Turning again to the aspect illustrated in FIG. 6, an anchor attachment detection sensor 30′ includes at least one of a strain gauge, an accelerometer, an acoustic transducer, a piezo-electric sensor, a load cell and a contact switch and the anchor attachment detection sensors 30″, 30″′ include at least one of a strain gauge, an accelerometer, an acoustic transducer, a piezo-electric sensor, a load cell or a contact switch. The sensors are affixed directly to the attachment loop 56 using, for example, chemical or mechanical means. For example, in aspects, the sensors are adhered to the attachment loop 56 using a polymer material such as potting cement, a thermoset adhesive, or thermoplastic adhesive, or the strain gauges are welded onto the attachment loop 56. In other aspects, the sensors are mechanically attached to the attachment loop 56 directly or indirectly, using clamps or other mechanical attachments as would be understood by those of skill in the art.

When the child safety seat connector 34 is coupled to the attachment loop 56, the child safety seat connector 34 applies a force F on the attachment loop 56 and the anchor attachment detection sensors 30′, 30″, 30″′. The anchor attachment detection sensors 30′, 30″, 30″′ detect the presence of the child safety seat connector 34 and transmits a control signal to the microprocessor control system 32 indicating a child safety seat connector 34 has been connected to the attachment loop 56. In further aspects, when tension at or greater a defined amount is applied to the child safety seat connector 34, the anchor attachment detection sensors 30′, 30″, 30″′ transmit a control signal to the microprocessor control system 32 indicating a child safety seat connector 34 has been connected to the attachment loop 56. Tension is applied to the child safety seat connector 34 by, e.g., adjusting either the strap(s) 20 or tether 26, depending on whether the attachment loop 56 is of a lower anchor 16 or an upper anchor 18.

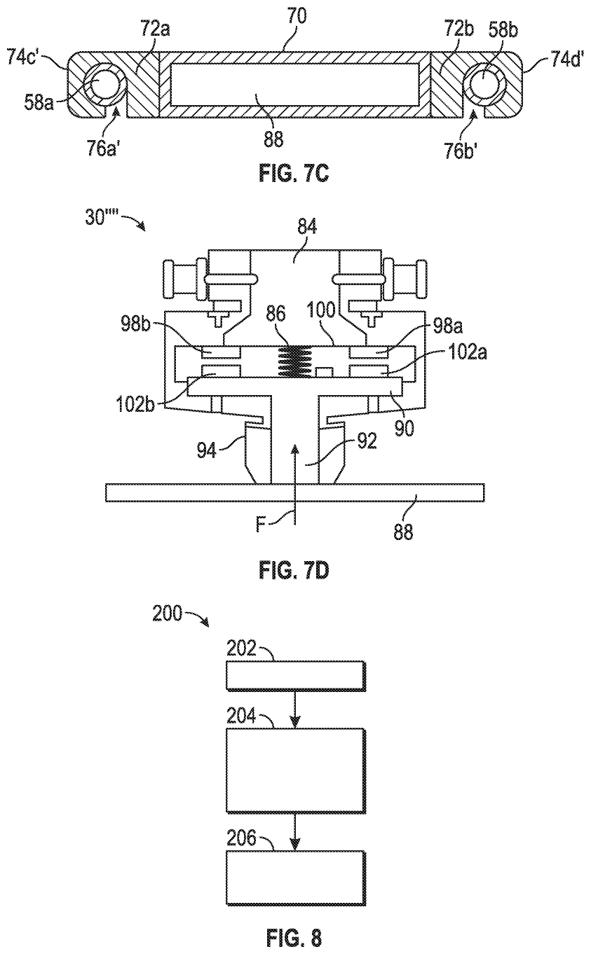

FIG. 7A through 7D illustrate a further aspect of an anchor attachment detection sensor 30″″ (again collectively referred to as anchor attachment detection sensor 30) including a clip 68 for affixing the anchor attachment sensor 30″″ to the attachment loop 56. As illustrated in FIG. 7A, the clip 68 includes a primary support 70 on which the anchor attachment detection sensor 30″″ is carried and two secondary supports 72a, 72b (collectively referred to herein as secondary supports 72) extending from the primary support 70. The anchor attachment detection sensor 30″″ includes any of the sensors noted above with respect to FIG. 6.

The secondary supports 72 each include prongs 74a, 74b, 74c, 74d (collectively referred to herein as prongs 74), illustrated in FIG. 7B, that extend around at least a portion of the attachment loop 56 and define a channel 76a, 76b (collectively referred to herein as channels 76) for receiving the attachment loop 56. In FIG. 7B, the prongs 74a, 74b, 74c and 74d extend around the attachment loop 56 in pairs; extending around to the opposing side of the attachment loop 56 from the secondary supports 72a, 72b, wherein a channel 76a, 76b is defined by each prong 74 pair. However, it should be appreciated that the prongs 74a, 74b, 74c, 74d may alternatively extend around the attachment loop 56 such that the channels 76a, 76b are defined by the prong and the secondary supports 72a, 72b as illustrated in FIG. 7C. The attachment loop 56 defines an interior perimeter 78 to which the clip 68 generally conforms. Further, the clip 68 also exhibits an interior perimeter 80. In the illustrated aspect, the anchor attachment detection sensor 30″″ affixed to the primary support 70 within the interior perimeter 80 defined by the clip 68.

In the aspect illustrated in FIGS. 7A and 7D, the anchor attachment detection sensor 30″″ includes a contact sensor, such as a contact switch. The anchor attachment detection sensor 30″″ also includes a sensor housing 84 affixed to the primary support 70. A spring 86 is connected to the sensor housing 84 and opposes the attachment loop 56 relative to the clip 68. An engagement plate 88 includes a carrier 90, which in turn is affixed to the spring 86 and is carried within the sensor housing 84. In aspects, the engagement plate 88 and carrier 90 are formed from a unitary piece. As illustrated the engagement plate 88 is affixed to the carrier 90 by spacer 92 that rides within a collar 94 defined by, or affixed to, the sensor housing 84.

Within the sensor housing 84 are two contacts 98a, 98b (collectively referred to herein as contacts 98) located on a base plate 100, which are engaged by the carrier 90 when a force F is applied to the engagement plate 88 with the child safety seat connector 34, biasing the spring 86. If sufficient force F is applied by the child safety seat connector 34, due to e.g., increasing the tension on the strap(s) 20 or the tether 26, the spring 86 will deform for the carrier 90 to interact with the contacts 98a, 98b. While two contacts 98a, 98b mounted to the base plate 100 are illustrated, only a single contact may be present or more than two contacts may be present. In aspects, the contacts 98 are piezo-sensors.

In further aspects, including the illustrated aspect, a second set of contacts 102a, 102b (collectively referred to as second contacts 102) are provided on the carrier 90 that align with the first set of contacts 102a, 102b on the base plate 100. In such an aspect, the first set of contacts 98 includes reed switches and the second set of contacts 102 includes magnets. In an alternative aspect, the first set of contacts 98 and the second set of contacts 102 are electrical conductors formed of electrically conductive materials such as copper, gold or silver. When the first set of contacts 98 engage the second set of contacts 102, a conductive circuit is closed. It should be appreciated that any of the sensors indicated herein may be used as the anchor attachment detection sensor 30″″, including a load sensor or strain gauge affixed to the primary support 70.

As may be appreciated from the above, the anchor attachment detection sensors 30 discussed herein are fully supported by the attachment loop. That is, it is not necessary to secure the anchor attachment detection sensor 30 to other structures associated with the passenger seat 12, other than the wires 104 (see FIG. 6) that carry signals to the microprocessor control system 32, and in aspects, the anchor attachment detection sensor 30 is not supported by any other structures associated with the passenger seat 12.

An aspect of a method 200 of detecting the attachment of a child safety seat connector 34 to one of a lower anchor 16 or upper anchor 18 in a motor vehicle is illustrated in FIG. 8. The method 200 begins at block 202 with sensing an interaction applied to an attachment loop 56 of an anchor 16, 18 with an anchor attachment detection sensor 30 supported by the attachment loop 56 and at block 204 determining with a microprocessor control system 32 coupled to the anchor attachment detection sensor 30 if a child safety seat connector 34 has been coupled to the attachment loop 56. This determination is made based on a control signal transmitted by the anchor attachment detection sensor 30. In aspects, the control signal indicates the attachment of the child seat restraint connector 34 and, in further aspects, also indicates the force applied to the attachment loop 56 and the anchor attachment detection sensor 30.

In aspects, the method 200 of blocks 202 and 204 is run for each lower anchor 16 and upper anchor 18 associated with a given passenger seat 12. At block 206, the method 200 includes providing a warning or taking a ride action if the microprocessor control system 32 determines that an a child safety seat 10 is present in the passenger seat 12 by the attachment of at least one child safety restraint connector 34 to at least one anchor 16, 18 associated with the passenger seat 12. For example, a warning at block 206 may indicate the use of a child safety seat 10 if the microprocessor control system 32 determines that a child safety seat connector 34 is connected to all of the anchors 16, 18. In another example, a warning at block 206 may indicate one or more incorrectly affixed child safety seat connectors 34. A ride action taken may include at least one of the following: deactivating the airbag 112, preventing a ride from occurring, and ending a ride in progress. This method 200 is repeated after a given time interval, after the start of a vehicle, or after the sensing of the attachment of a child safety seat connector 34 to either a lower anchor 16 or upper anchor 18.

An anchor attachment detection sensor of the present disclosure offers several advantages. These include the ability to detect the connection of a child safety seat connector to an attachment loop of a LATCH anchor. The anchor attachment detection sensors are also relatively low profile compared to anchor attachment detection sensors affixed to other locations relative to the anchor. Further, the anchor attachment detection sensors may be easily interchanged by removing the anchor itself or replacing clip on sensors, without the need to replace other components in the passenger seat.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An anchor attachment detection sensor for a vehicle, comprising:
an anchor associated with a passenger seat, the anchor including an attachment loop; and
a sensor affixed on and fully supported by the attachment loop, wherein the sensor detects an interaction applied to the attachment loop and sensor by a child safety seat connector.

2. The anchor attachment detection sensor of claim 1, wherein the interaction applied to the attachment loop includes one of the following: a force applied to the attachment loop, a strain on the attachment loop, a vibration of the attachment loop, noise proximate to the attachment loop, and a displacement of the attachment loop.

3. The anchor attachment detection sensor of claim 1, wherein the sensor includes at least one sensor selected from the group consisting of a strain gauge, an accelerometer, an acoustic transducer, a piezo-electric sensor, a load cell, and a contact switch.

4. The anchor attachment detection sensor of claim 1, wherein the sensor is a strain gauge and the strain gauge measures both axial strain and bending strain.

5. The anchor attachment detection sensor of claim 3, wherein the sensor is a strain gauge.

6. The anchor attachment detection sensor of claim 1, wherein the sensor is a conductive paint.

7. The anchor attachment detection sensor of claim 1, wherein the sensor is chemically or mechanically connected to the attachment loop.

8. The anchor attachment detection sensor of claim 7, wherein the sensor is adhered to the attachment loop with a polymer material.

9. The anchor attachment detection sensor of claim 7, wherein the sensor is welded to the attachment loop.

10. The anchor attachment detection sensor of claim 7, wherein the sensor is mechanically affixed to the attachment loop.

11. The anchor attachment detection sensor of claim 10, further comprising a clip affixing the sensor to the attachment loop.

12. The anchor attachment detection sensor of claim 11, wherein the sensor includes one of a contact sensor and a load sensor.

13. The anchor attachment detection sensor of claim 11, wherein the sensor is a contact sensor that includes a contact switch.

14. The anchor attachment detection sensor of claim 11, wherein the clip defines a perimeter and the sensor is located within the perimeter.

15. The anchor attachment detection sensor of claim 11, wherein the attachment loop includes at least two side arms and the clip attaches to the at least two side arms.

16. The anchor attachment detection sensor of claim 15, wherein the sensor is a contact sensor comprising:
a sensor housing connected to the clip;
a base plate located within the sensor housing;
a spring connected to the base plate;
an engagement plate extending between the at least two side arms, the engagement plate connected to the spring; and
a first sensor contact mounted to the base.

17. The anchor attachment detection sensor of claim 16, wherein the first sensor contact is a reed switch and the engagement plate includes a second contact, wherein the second contact includes a magnet.

18. The anchor attachment detection sensor of claim 16, wherein the first sensor contact is a piezo-electric sensor.

19. The anchor attachment detection sensor of claim 16, wherein the first sensor contact is a first electrical conductor and the engagement plate includes a second contact, wherein the second contact is a second electrical conductor.

20. A method of detecting the attachment of a child safety seat connector to an anchor in a motor vehicle, comprising:
detecting an interaction of the child safety seat connector with an attachment loop of an anchor using a sensor supported by the attachment loop; and
determining with a microprocessor control system coupled to the sensor if a child safety seat connector has been coupled to the anchor based on the interaction detected by the sensor.
